(19) United States
(12) Patent Application Publication
(10) Pub. No.: US 2007/0118578 A1
(43) Pub. Date: May 24, 2007

(54) Extensible hashing for file system directories

(75) Inventors: Matthew A. Ahrens, San Francisco, CA (US); Mark J. Maybee, Boulder, CO (US)

Correspondence Address: OSHA LIANG L.L.P./SUN, 1221 MCKINNEY, SUITE 2800, HOUSTON, TX, 77010, US

(73) Assignee: Sun Microsystems, Inc., Santa Clara, CA (US)

(21) Appl. No.: 11/432,263

(22) Filed: May 11, 2006

Related U.S. Application Data
(60) Provisional application No. 60/733,850, filed on Nov. 4, 2005.

(51) Int. Cl. G06F 17/30

(52) U.S. Cl. 707/205

(57) ABSTRACT

In general, embodiments of the invention relate to a disk, which includes a plurality of files and rectory associated with the plurality of files comprising a plurality of directory entries. Further, each of the plurality of directory entries is associated one of the plurality of files and each of the plurality of directory entries is associated with a collision differentiator (CD). In one aspect of the invention, a hash value calculated for each of the plurality of directory entries is used to determine the CD associated with each of the plurality of directory entries.

### CROSS REFERENCE TO RELATED APPLICATIONS

This application claims benefit of U.S. Provisional Application Ser. No. “Extensible Hashing for File System Directories” (Application Ser. No. 60/733,850) filed on Nov. 4, 2005 in the names of Matthew A. Ahrens and Mark J. Maybee and is hereby incorporated by reference.

### BACKGROUND

File systems include directories, where the directories provide a means for organizing the contents of the file system. The directory includes a number of directory entries. Each directory entry is as a <name, value> pair, where name corresponds to string, typically 1 to 255 characters in length and the value corresponds to a fixed-size number (e.g., 32 bits). No additional metadata is stored with (or in) the directory entry.

When the directory entries are stored on disk, they are stored in accordance with an on-disk format. Typically, the on-disk format corresponds to storing each directory entry as a <name, value> pair in the order in which the directory entry was added to the directory. Said another way, the directory entries are laid out on disk in a sequential manner, based on the order in which the directory entry was added to the directory. Further, each new directory entry added to the directory is stored after the last directory entry that was stored in the directory. Thus, once a directory entry is laid on disk, its location does not change.

File systems typically include functionality to perform various actions on a directory. These actions typically include: inserting a new directory entry, removing a directory entry, looking up a specific directory entry, and listing all the entries in a directory. With respect to listing all directory entries in the directory, the file system (or a process associated with the file system) starts at the location of the first directory entry on disk and proceeds to sequentially read the directory entries from disk. If the listing operation is halted (or pauses) prior to completing the listing of all entries in the directory, then the file system (or the process associated with the file system) tracks the last physical location on disk, from which a directory entry was obtained. Once the listing operation resumes, the listing operation obtains the last physical location and starts listing directory entries from this location.

### SUMMARY

In general, in one aspect, the invention relates to a disk, which includes plurality of files, a directory associated with the plurality of files comprising a plurality of directory entries, wherein each of the plurality of directory entries is associated one of the plurality of files, wherein each of the plurality of directory entries is associated with a collision differentiator (CD), wherein a hash value calculated for each of the plurality of directory entries is used to determine the CD associated with each of the plurality of directory entries.

In general, in one aspect the invention relates to method for inserting a new directory entry into a directory, which includes obtaining a calculated hash value for the new directory entry, determining whether the calculated hash value is equal to a hash value associated with any of a plurality of directory entries currently stored in the directory, if the calculated hash value is equal to a hash value associated with any of the plurality of directory entries currently stored in the directory, determining a lowest unused collision differentiator (LCD) associated with any of the plurality of directory entries associated with the hash value equal to the calculated hash value, associating the new directory entry with a new CD, wherein the new CD is set to LCD, and if the calculated hash value is not equal to a hash value associated with any of the plurality of directory entries currently stored in the directory: associating the new directory entry with the new CD, wherein the new CD is set to zero, and storing the new directory entry and the new CD in the directory using the hash value and the new CD.

In general, in one aspect, the invention relates to a method for listing directory entries in a directory, that includes retrieving a first potion of directory entries, wherein the first portion of directory entries are retrieved in <hash value, collision differentiator (CD)> order, determining a cookie associated with last directory entry retrieved in the first portion of directory entries, wherein the cookie comprises a <hash value, CD> pair for the last directory entry, and retrieving a second portion of directory entries starting at a directory entry after a directory entry referenced by the cookie.

Other aspects of the invention will be apparent from the following description and the appended claims.

### BRIEF DESCRIPTION OF DRAWINGS

FIG. 1A shows a block diagram for a disk in accordance with one embodiment of the invention.

FIG. 1B shows a block diagram of a directory entry in accordance with one embodiment of the invention.

FIGS. 2 and 3 show data structures for organizing directory entries in a directory in accordance with one or more embodiments of the invention.

FIGS. 4 and 5 show flowcharts in accordance with one embodiment of the invention.

FIG. 6 shows a computer system in accordance with one embodiment of the invention.

### DESCRIPTION

Specific embodiments of the invention will now be described in detail with reference to the accompanying figures. Like elements in the various figures are denoted by like reference numerals for consistency.

In the following detailed description of one or more embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

In general, embodiments of the invention relate to a method and system for organizing a file system directory on disk. More specifically, embodiments of the invention relate to a method and apparatus for using extensible hashing techniques to organize directory entries on disk and to retrieve directory entries from the disk.

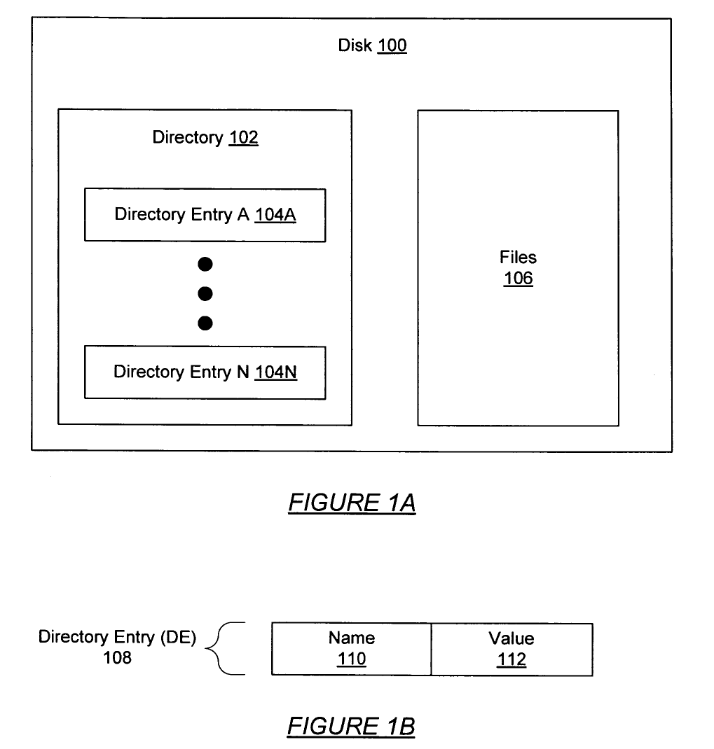

FIG. 1A shows a block diagram of a disk in accordance with one embodiment of the invention. As shown in FIG. 1A, the disk (100) is configured to store files (106) as well as a directory (102) referencing the files (106). In particular, the directory (102) includes at least one directory entry (e.g., directory entry A (104A), directory entry N (104N)) for each file (106) on the disk (100).

FIG. 1B shows a directory entry (DE) in accordance with one embodiment of the invention. As shown in FIG. 1B, the DE (108) includes a name (110) and a value (112). In one embodiment of the invention, the name (110) corresponds to the name of a file and is represented by a string. In one embodiment of the invention, the string typically has between 1 to 255 characters. In one embodiment of the invention, the value (112) corresponds to a numeric value and/or alpha numeric value, where the value (112) is used by the file system (not shown).

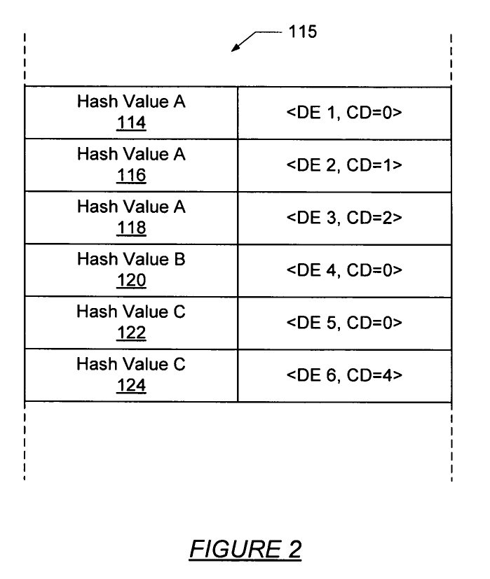

FIG. 2 shows a block diagram of a data structure for organizing directory entries in a directory in accordance with one or more embodiments of the invention. As shown in FIG. 2, the DEs (e.g., DE 1, DE 2, DE 3, DE 4, DE 5, DE 6) may be stored in a hash table (115). In one embodiment of the invention, the DEs (e.g., DE 1, DE 2, DE 3, DE 4, DE 5, DE 6) are stored in hash value order (i.e., hash value A (114, 116, 118) , hash value B (120), hash value C (122, 124))). Further, if two DEs have the same hash value (e.g., hash value A (114, 116, 118)), then the DEs are organized based on the collision differentiator (CD) value (described below) associated with the DE (e.g., DE 1, DE 2, DE 3, DE 4, DE 5, DE 6). For example, DE 1, DE 2, and DE 3 all have the same hash value (e.g., hash value A (114, 116, 118)), thus, the CD associated with each of the DEs (i.e., DE 1, DE 2, DE 3) is evaluated to determine the order of the DEs. In this case, DE 1 has a CD=0, DE 2 has a CD=1, DE 3 has a CD=2. Accordingly, the DEs are organized as follows: DE 1, DE 2, and DE 3 in the hash table (115).

In one embodiment of the invention, the hash value (114, 116, 118, 120, 122, 124) associated with a given DE (e.g., DE 1, DE 2, DE 3, DE 4, DE 5, DE 6) may be obtained using any hashing algorithm (e.g., Message Digest (MD)-5). Further, the entire DE (i.e., the name and the value) or a portion of the DE may be used as input to the hashing algorithm.

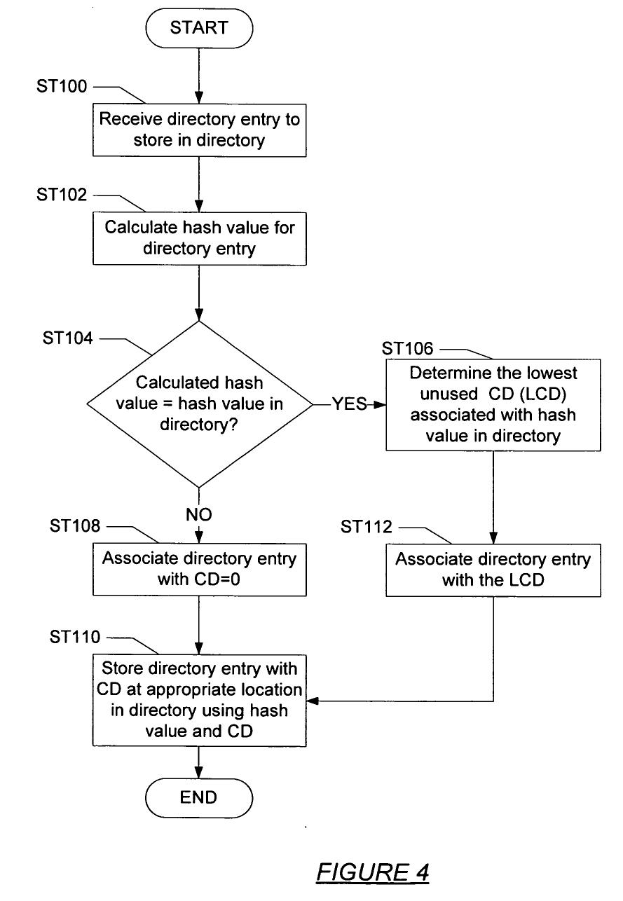

In one embodiment of the invention, the CD corresponds to an n-bit value. The CD is associated with DE at the time the DE is inserted into the directory. The calculation of the CD for a given entry is discussed in FIG. 4. In one embodiment of the invention, the CD may be included within the value portion of the DE (see FIG. 1B). For example, if the value portion is a 64-bit number, then the CD may correspond to the last 8 bits. Alternatively, the CD may be appended to the DE.

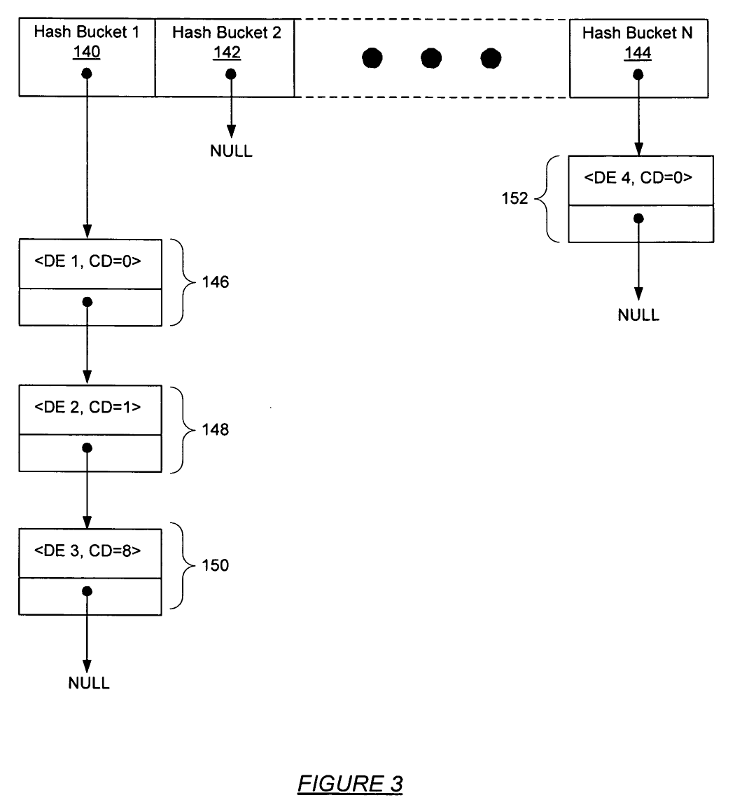

FIG. 3 shows a data structure for organizing directory entries in a directory in accordance with one or more embodiments of the invention. As an alternative to storing the DEs in a hash table. The DEs may be stored in hash buckets (140, 142, 144). The data structure may include a number of hash buckets (140, 142, 144) where each hash bucket corresponds to a single hash value. In one embodiment of the invention, hash buckets (140, 142, 144) may be created at run-time (i.e., when a new hash bucket is required, then a new hash bucket is created). In one embodiment of the invention, the hash buckets (140, 142, 144) are implemented using an array. Alternatively, the hash buckets (140, 142, 144) may be implemented using a linked list.

In one embodiment of the invention, each hash bucket (140, 142, 144) includes a pointer to a head of a linked list, where the linked list includes all the DEs that have the same hash value. In addition, the DEs in the linked list are organized such that DEs, starting at the head, are organized in ascending CD order. For example, hash bucket 1 (140) points to a linked list that includes three entries: a first entry containing DE 1 (146), a second entry containing DE 2 (148), and a third entry containing DE 3 (150). Further, DE 1 is associated with CD=0, DE 2 is associated with CD=1, and DE 3 is associated with CD=8. In one embodiment of the invention, each hash bucket (140, 142, 144) may include a pointer to an array as opposed to a linked list.

Further, those skilled in the art will appreciate that not all has buckets (140, 142, 144) may be associated with an entry. For example, hash bucket 2 (142) is not associated with any entries. Further, each hash bucket (140, 142, 144) may include a variable number of entries. For example, hash bucket 1 (140) includes three entries (146, 148, 150), while hash bucket N (144) only includes one entry (152).

FIG. 4 shows a flowchart in accordance with one embodiment of the invention. More specifically, FIG. 4 shows a method for inserting a directory entry into a directory in accordance with one embodiment of the invention. Initially, a directory entry is received (ST100). A hash value for the directory entry is subsequently calculated (ST102). A determination is then made about whether the calculated hash value (i.e., the hash value calculated in ST102) is equal to a hash value for a directory entry currently stored in the directory (ST104).

If the calculated hash value is equal to a hash value for a directory entry currently stored in the directory, then the lowest unused CD (LCD) associated with all of directory entries having the same hash value is determined (ST106).

For example, if the directory includes three directory entries having hash values equal with CD's equal to 0, 1, and 99, then the LCD would be 2. Alternatively, if the CD's were 0, 1, and 2, then LCD would be 3. Note that the use of LCD allows the directory to support arbitrary remove of entries and reuse of CD's associated with a given hash value.

Returning to FIG. 4, once the LCD is determined, the CD for the directory entry to be inserted into the directory (i.e., the directory entry received in ST100) is set to equal the LCD (ST112). The process then proceeds to ST110.

Alternatively, if the calculated hash value is not equal to a hash value for any directory entry currently stored in the directory, then a CD=0 is associated with the directory entry to be inserted into the directory (i.e., the directory entry received in ST100) (ST108). Once the CD for the directory entry to be inserted into the directory (i.e., the directory entry received in ST100) is determined (see ST104, ST106, ST108, ST112), the directory entry along with the associated CD is stored in the directory at a location determined using the hash value and the CD (ST110). In one embodiment of the invention, the hash value is also stored with the directory entry and CD.

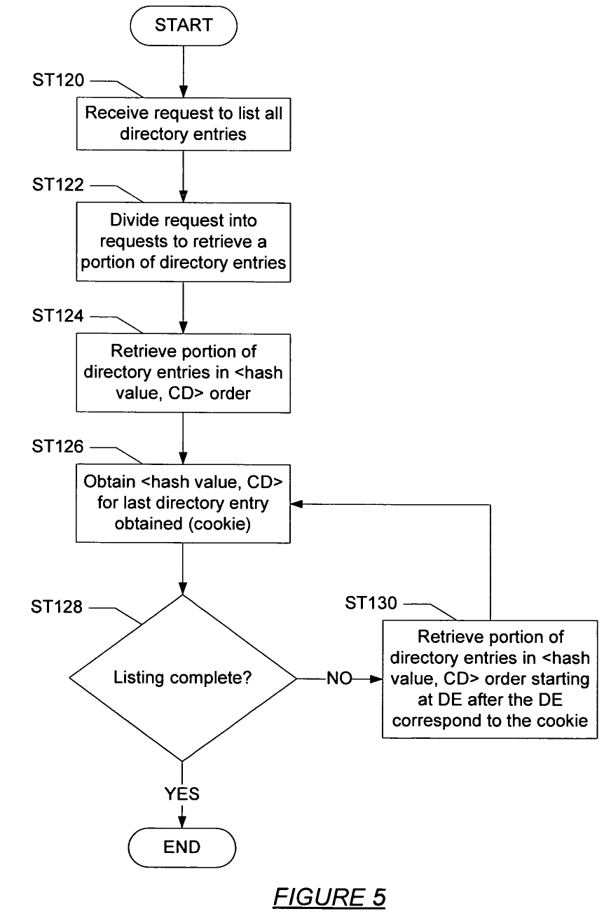

FIG. 5 shows a flowchart in accordance with one embodiment of the invention. More specifically, FIG. 5 shows a method for listing all entries in a directory. Initially, a request is received to list all entries in the directory (ST120). The request is subsequently divided into requests to retrieve portions of the directory entries (ST122). A portion of directory entries is then retrieved in <hash value, CD> order (ST124). The <hash value, CD> (i.e., a cookie) for the last directory entry retrieved in ST124 or ST130 (discussed below) is then obtained and temporarily stored (ST126).

A determination is then made about whether the listing of all directory entries is complete (ST128). If all directory entries have been listed (i.e., the cookie corresponds to the last directory entry in <hash value, CD> order), then the process ends. Alternatively, if there are remaining directory entries to retrieve, then another portion of directory entries is retrieved starting at the directory entry following the directory entry corresponding to the cookie (ST130). The process then proceeds to ST126. Those skilled in the art will appreciate that the number of directory entries retrieved in each portion may vary from implementation to implementation.

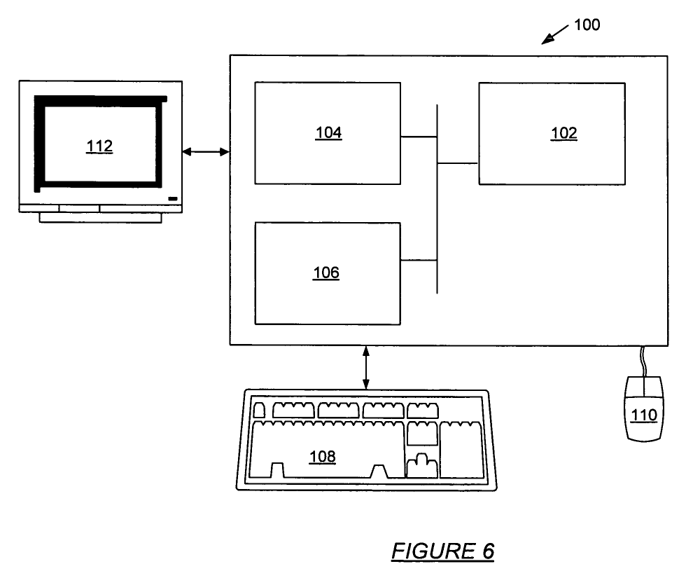

The invention may be implemented on virtually any type of computer regardless of the platform being used. For example, as shown in FIG. 6, a networked computer system (100) includes a processor (102), associated memory (104), a storage device (106), and numerous other elements and functionalities typical of today's computers (not shown). The networked computer (100) may also include input means, such as a keyboard (108) and a mouse (110), and output means, such as a monitor (112). The networked computer system (100) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer (100) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A disk, comprising:
a plurality of files;
a directory associated with the plurality of files comprising a plurality of directory entries,
wherein each of the plurality of directory entries is associated one of the plurality of files,
wherein each of the plurality of directory entries is associated with a collision differentiator (CD),
wherein a hash value calculated for each of the plurality of directory entries is used to determine the CD associated with each of the plurality of directory entries.

2. The disk of claim 1, wherein each of the plurality of directory entries is stored in one a plurality of hash buckets and wherein all directory entries within a given hash bucket are associated with the same hash value.

3. The disk of claim 1, wherein none of the directory entries in the given hash bucket have the same CD.

4. The disk of claim 1, wherein the CD is an integer.

5. The disk of claim 1, wherein each of the plurality of directory entries comprises a 64-bit value, wherein 56-bits corresponds to a value and a 8 bits corresponds to the CD associated with the one of the plurality of directory entries.

6. The disk of claim 1, wherein each of the plurality of directory entries is stored on the disk with the CD associated with the one of the plurality of directory entries.

7. The disk of claim 1, wherein each of the plurality of directory entries is stored in a hash bucket.

8. The disk of claim 1, wherein the directory is associated with a file system.

9. A method for inserting a new directory entry into a directory comprising:
obtaining a calculated hash value for the new directory entry;
determining whether the calculated hash value is equal to a hash value associated with any of a plurality of directory entries currently stored in the directory;
if the calculated hash value is equal to a hash value associated with any of the plurality of directory entries currently stored in the directory:
determining a lowest unused collision differentiator (LCD) associated with any of the plurality of directory entries associated with the hash value equal to the calculated hash value;
associating the new directory entry with a new CD, wherein the new CD is set to LCD; and
if the calculated hash value is not equal to a hash value associated with any of the plurality of directory entries currently stored in the directory:
associating the new directory entry with the new CD, wherein the new CD is set to zero; and
storing the new directory entry and the new CD in the directory using the hash value and the new CD.

10. The method of claim 9, wherein each of the plurality of directory entries is stored in one a plurality of hash buckets and wherein all directory entries within one of the plurality of hash buckets are associated with the same hash value.

11. The method of claim 10, wherein none of the directory entries in the one of the plurality of hash buckets have the same CD.

12. The method of claim 9, wherein the CD is an integer.

13. The method of claim 1, wherein the new CD is stored in a last 8 bits of a 64-bit value associated with the new directory entry.

14. A method for listing directory entries in a directory, comprising:
retrieving a first potion of directory entries, wherein the first portion of directory entries are retrieved in <hash value, collision differentiator (CD)> order;
determining a cookie associated with last directory entry retrieved in the first portion of directory entries, wherein the cookie comprises a <hash value, CD> pair for the last directory entry; and
retrieving a second portion of directory entries starting at a directory entry after a directory entry referenced by the cookie.

15. The method of claim 14, wherein each of the directory entries is stored in one of a plurality of hash buckets and wherein all directory entries within one of the plurality of hash buckets are associated with the same hash value.

16. The method of claim 15, wherein none of the directory entries in the one of the plurality of hash buckets have the same CD.

17. The method of claim 14, wherein the CD is an integer.

18. The method of claim 14, wherein each of the directory entries is associated with a name, a value, and CD.

19. The method of claim 18, wherein the value and the CD are stored in a 64-bit number.

20. The method of claim 19, wherein the CD is stored in a last 8 bits of the 64-bit number.
